(19) United States
(12) Patent Application Publication
(10) Pub. No.: US 2016/0205908 A1
(43) Pub. Date: Jul. 21, 2016

(54) Bladed Jig Head

(71) Applicant: Horst Dieter Stanford, Cuthbert, GA (US)

(72) Inventor: Horst Dieter Stanford, Cuthbert, GA (US)

(21) Appl. No.: 14/986,414

(22) Filed: Dec. 31, 2015

Related U.S. Application Data
(60) Provisional application No. 62/105,031, filed on Jan. 19, 2015.

(51) Int. Cl. A01K 85/10; A01K 83/00

(52) U.S. Cl. CPC A01K 85/10; A01K 83/00

(57) ABSTRACT

A bladed jig head includes a hook, a weighted jig mold, a plurality of lure skirts, a shape-memory blade arm, and a spinner blade. A shank of the hook and the shape-memory blade arm are perpendicularly connected to each other by the weighted jig mold as the weighted jig mold is positioned adjacent to an eye of the hook. The spinner blade is rotatably attached to the shape-memory blade arm by a swivel to produce flash and vibration such that emitting flash and vibration effectively lure fish toward the bladed jig head. The shape-memory blade arm and the spinner blade configuration also protects a barbed end of the hook from getting caught in obstructions as the bladed jig head is utilized for fishing.

The current application claims a priority to the U.S. Provisional Patent application Ser. No. 62/105,031 filed on Jan. 19, 2015.

### FIELD OF THE INVENTION

The present invention relates generally to an apparatus for a fishing lure. More specifically, the present invention is able to protect the hook from getting snagged while providing vibration and flash to attract fish.

### BACKGROUND OF THE INVENTION

Two of the most popular fishing lures in the industry are the spinner-bait and the jig-bait. Both are effective; however, both the spinner-bait and the jig-bait have weaknesses and limitation in relation to number of fish that is lost due to poor hook percentage and number to lures is lost due to underwater obstructions. The spinner-bait normally produces vibration and flash both of which attract fish towards the lure. The biggest weakness of the spinner bait is the number of fish that is lost, because it is hard to set the hook. Since the hook is located at the end of a flexible wire shaft, the hook makes for a little penetration of hook into the fish's mouth. The spinner-bait also tends to tangle in any sort of weed, limb or vegetation in the water. The jig-bait is popular since it can be utilized to fish in heavy cover or weeds. A bladed jig-bait that has a blade attached to the eye of the hook can possess the flash and vibration to attract fish. The drawback to this configuration is that the hook is exposed, and the hook very susceptible to getting hung up when fished close to the kind of structure that fish are often found in. Another type is the bottom spin jig-bait. The blade is attached to the bottom of this type of jig-bait as the name suggests. This configuration provides a little flash and vibration, but also tends to get hung up due to the unprotected hook when fished close to the kind of structure that fish are often found in. Another type is the jig-bait that lacks the flash and vibration of the spinner-bait. As a result, this configuration of jig-bait lacks the large number fish attractions compare to the spinner-bait. All of these different types of baits work best when fished in open water, where fish are not as likely to be.

It is an objective of the present invention to provide a bladed jig head that only possess the effective and best qualities of existing baits. The present invention allows fishermen to fish in heavy cover without fear of losing their lure. The present invention's uniquely attached flex wire produces both flash and vibration. By having this flex-wire centrally located on the top of the jig head, the flex wire protects the hook's barbed end from getting caught in cover or weeds. The unique shape of the jig head allows the nose of the lure to deflect off from obstruction instead of becoming lodged or stuck in them. The unique shape of the jig head also causes the present invention to swim in the erratic manner of a bait fish. The purpose of the present invention is to have a jig head and a flexible wire to protect the barbed end from obstructions, but be able to collapse as a fish strikes allowing for a solid bite and fewer missed fish while emitting a pulsing vibration and reflected flashes to attract fish.

### BRIEF DESCRIPTION OF THE DRAWINGS

FIG. 1 is a perspective view of the present invention

FIG. 2 is a side view of the present invention.

FIG. 3 is a perspective view of the present invention, without the plurality of lure skirts.

FIG. 4 is a side view of the present invention, without the plurality of lure skirts.

FIG. 5 is a side view of the hook of the present invention.

FIG. 6 is a side view of the shape-memory blade arm of the present invention.

FIG. 7 is a front view of the present invention, without the plurality of lure skirts, showing the plane upon which a cross sectional view is taken shown in FIG. 8.

FIG. 8 is a cross section view of the present invention, without the plurality of lure skirts, taken along line A-A of FIG. 7.

### DETAIL DESCRIPTIONS OF THE INVENTION

All illustrations of the drawings are for the purpose of describing selected versions of the present invention and are not intended to limit the scope of the present invention.

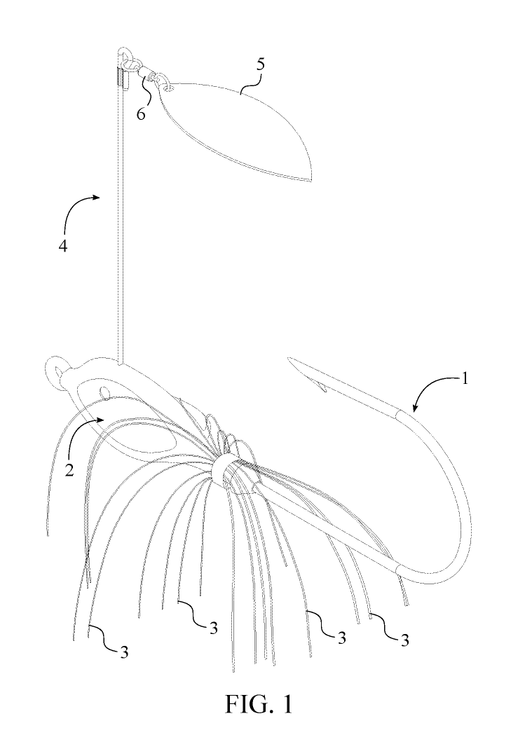

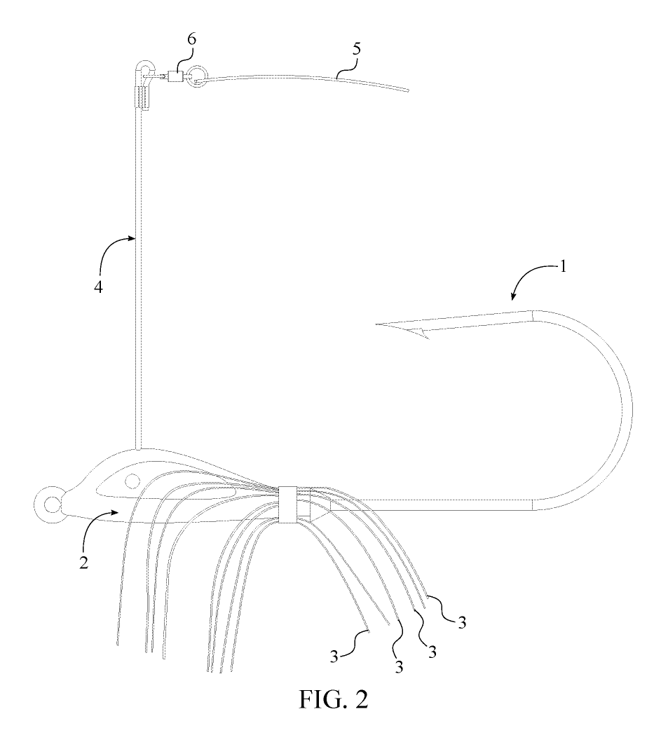

The present invention is a bladed jig head that is utilized as an improved fishing lure compare to existing fishing lures. The present invention combines effective outcomes from two of the most popular fishing lures, the spinner-bait and jig-bait, into a single apparatus so that the fishermen are able to eliminate the weaknesses of the spinner-bait and jig-bait through the present invention. As shown in FIGS. 1-2, the present invention comprises a hook 1, a weighted jig mold 2, a plurality of lure skirts 3, a shape-memory blade arm 4, and a spinner blade 5. In reference to the general configuration of the present invention, a shank 12 of the hook 1 and the shape-memory blade arm 4 are perpendicularly connected to each other by the weighted jig mold 2 such that the hook 1, the shape-memory blade arm 4, and the weighted jig mold 2 form a L-shaped structure within the present invention. The plurality of lure skirts 3 is perimetrically attached around the weighted jig mold 2 and conceals the hook 1 from the fish. The spinner blade 5 that provides vibration and flash is rotatably attached to the shape-memory blade arm 4 by a swivel 6 as the spinner blade 5 and the weighted jig mold 2 are oppositely positioned of each other along the shape-memory blade arm 4.

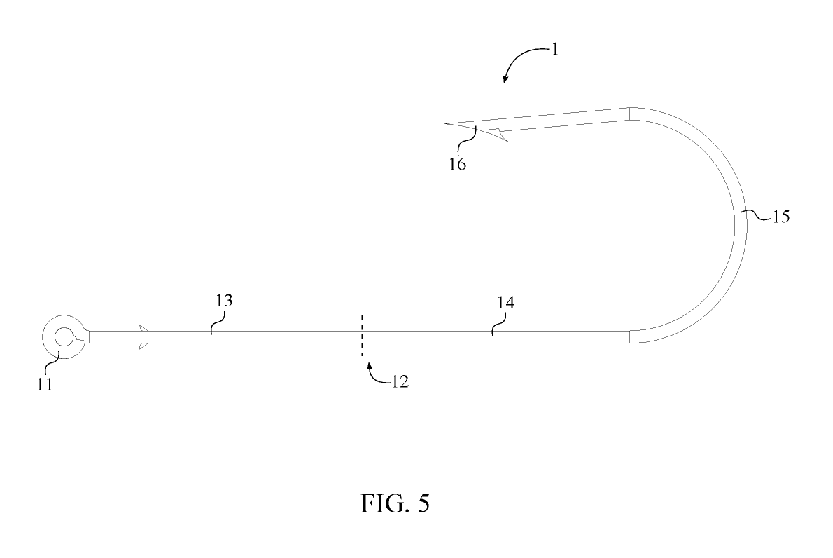

The hook 1 can be shaped into different hook-styles that are suitable for fabrication of the present invention and can be manufactured from stainless, carbon steel, any other suitable material. In reference to FIG. 5 and FIGS. 7-8, the hook 1 comprises an eye 11, a bend 15, and a barbed end 16 in addition to the shank 12. More specifically, the barbed end 16 is adjacently positioned with the bend 15 forming the throat and the gape of the hook 1. The shank 12 is adjacently positioned with the bend 15 and positioned opposite of the barbed end 16 to provide the necessary distance between the bend 15 and the eye 11. The eye 11 is adjacently positioned with the shank 12 and positioned opposite of the bend 15. The eye 11 provides an opening for a fishing line to loop through so that the present invention can be secured to the fishing line. The hook 1 further comprises a first barb and a second barb. More specifically, the first barb and the second barb are radially positioned around the shank 12, adjacent to the eye 11. The first barb is projected toward the barbed end 16 and the second barb is projected opposite of the first barb. As a result of the first and second barb, the weighted jig mold 2 can be firmly secured to the hook 1, increasing the connection strength between the hook 1 and the weight jig mold 2.

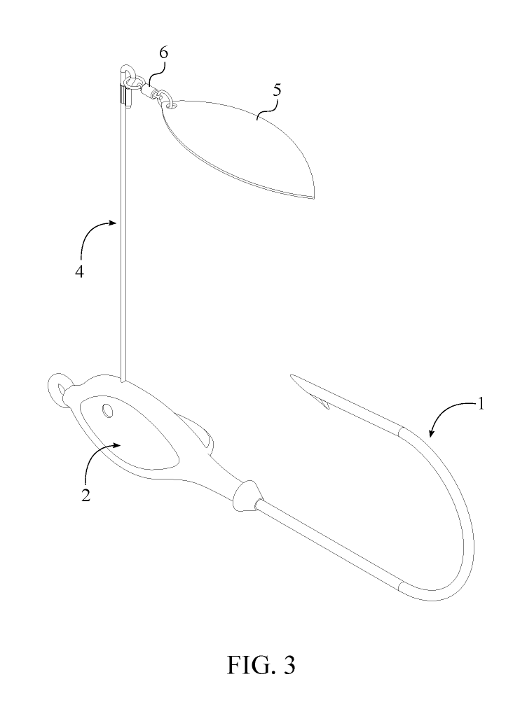

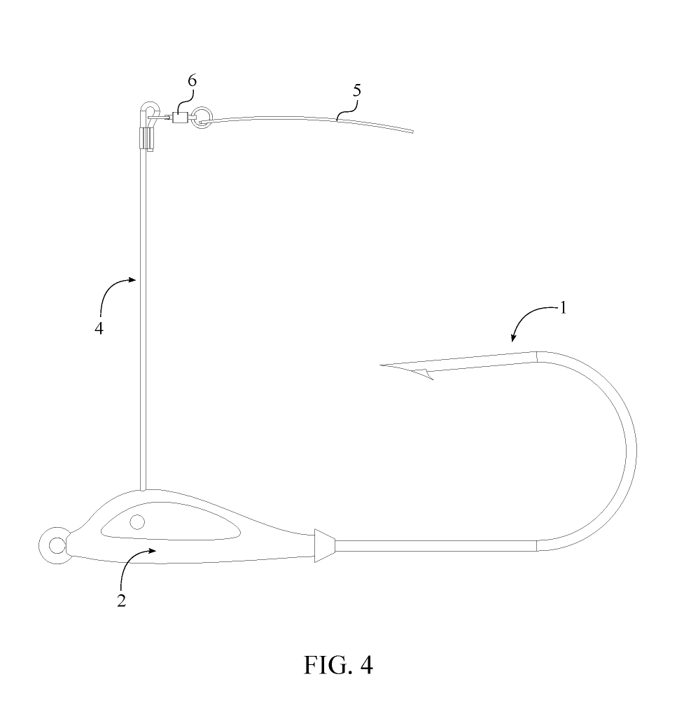

The weighted jig mold 2 that provides the sufficient weight to the present invention is molded into a hull shaped head. In reference to FIGS. 3-4, the hull shaped head allows the nose of the present invention to deflect off of obstructions instead of becoming lodged or stuck in them. The hull shaped head comprises a keel shaped bottom surface to glide across vegetation rather that to bury in it. The keel shape bottom surface also causes the present invention to swim in the erratic manner of a bait fish. The weighted jig mold 2 may further comprises a pair of eyes and a protective coating. The pair of eyes visually transforms the present invention into a live bait fish to attract fish while the protective coating safeguards the weighted jig mold 2 from unnecessary environmental elements.

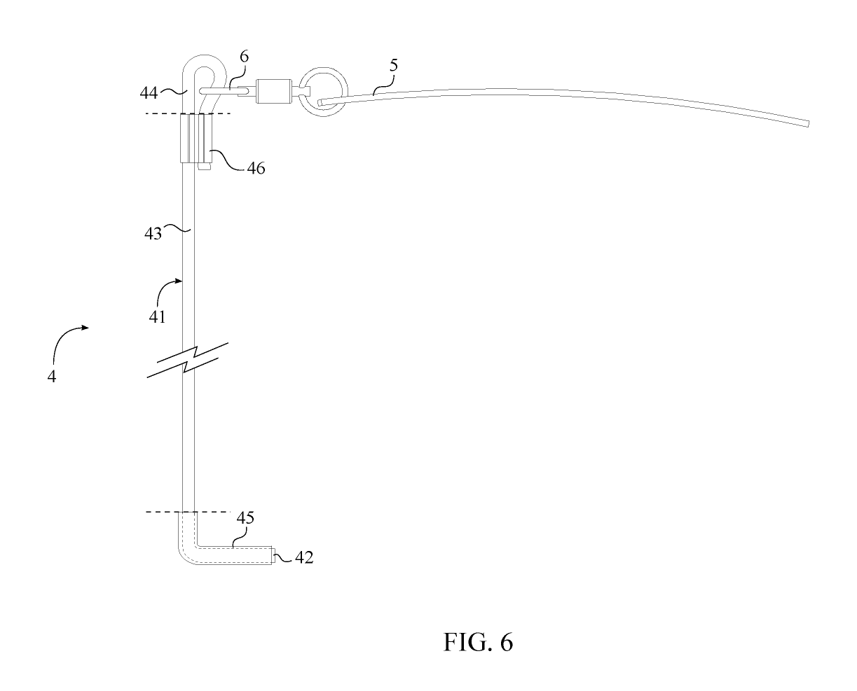

The shape-memory blade arm 4 has the ability to bend and return to its original form within the present invention. As a result, the shape-memory blade arm 4 collapses at a fish's bit and then regain its original shape. Additionally, the strength and the elasticity of the shape-memory blade arm 4 prevents the present invention from becoming caught on trash, wood, or other cover by protecting the barbed end 16 from becoming lodged. In reference to FIG. 6, the shape-memory blade arm 4 comprises a superelastic wire 41, a L-shaped sleeve 45, and a double barrel clamp sleeve 46. The superelastic wire 41 is preferably made from Nitinol so that the shape-memory blade arm 4 is able to efficiently function within the present invention. The superelastic wire 41, preferably 0.020 inch in diameter, comprises a L-shaped bend section 42, an elongated section 43, and an U-shaped bend section 44. The L-shaped bend section 42 is adjacently positioned with the elongated section 43 while the U-shaped bend section 44 is adjacently positioned with the elongated section 43, opposite of the L-shaped bend section 42. In order to retain the L-shaped bend section 42 and the U-shaped bend section 44 within the present invention, the shape-memory blade arm 4 respectively utilizes the L-shaped sleeve 45 and the double barrel clamp sleeve 46. More specifically, the L-shaped bend section 42 is encircled by the L-shaped sleeve 45 to maintain the form and structure of the L-shaped bend section 42. Similarly, the U-shaped bend section 44 is crimped onto the elongated section 43 by the double barrel clamp sleeve 46 to maintain the form and the structure of the U-shaped bend section 44.

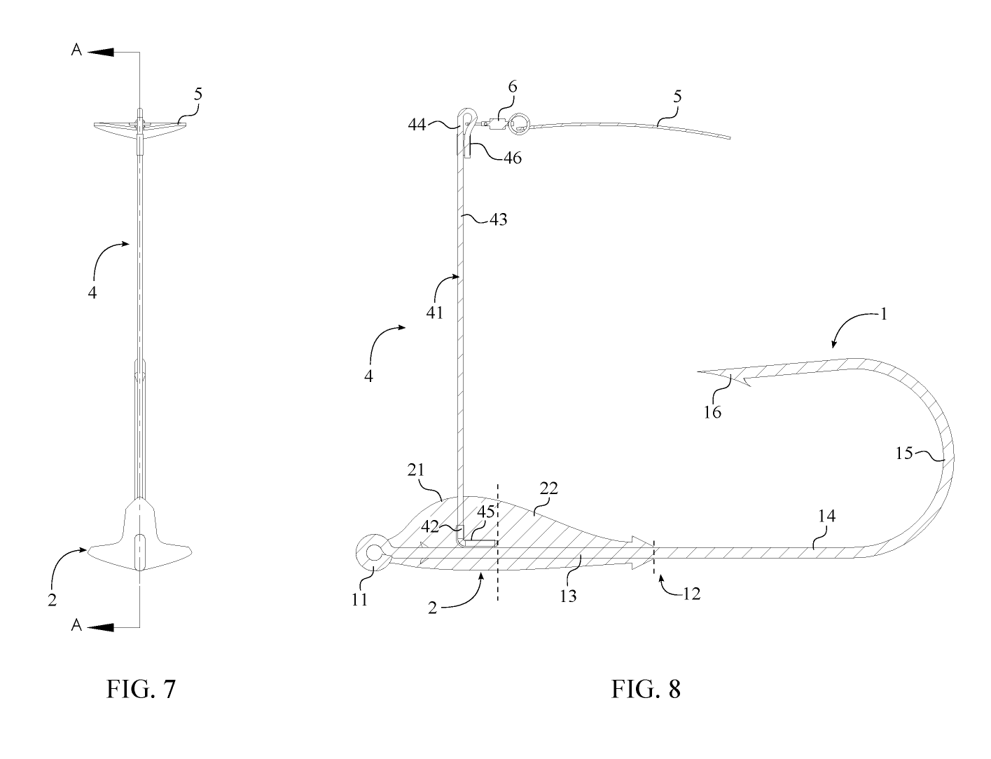

In reference to FIG. 7-8, the L-shaped sleeve 45 and the L-shaped bend section 42 are adjacently positioned with the eye 11 of the hook 1 as the elongated section 43 is oriented perpendicular to the shank 12. As a result of the L-shaped sleeve 45 and the shank 12, the shape-memory blade arm 4 is able to perpendicularly connect with a first end 13 of the shank 12 through the weighted jig mold 2 as the L-shaped sleeve 45 and the first end 13 of the shank 12 are encircled by the weighted jig mold 2. More specifically, a front portion 21 of the weighted jig mold 2 is adjacently positioned with the eye 11 while the rear portion 22 of the weighted jig mold 2 is adjacently positioned with a second end 14 of the shank 12. Depending upon the angle of the present invention and the positioning of the weighted jig mold 2, the plurality of lure skirts 3 is able to selectively conceal the rear portion 22, the second end 14, the bend 15, and the barbed end 16 to visually mimic a live bait fish through the present invention. The plurality of lure skirts 3 can be colored, shaped, textured according to industry standards and preferences to accommodate different types of fishes, different time periods, and different seasons.

In reference to FIG. 1-4, the spinner blade 5 is rotatably secured within the U-shaped bend section 44 and the double barrel clamp sleeve 46 by the swivel 6. As a result, the shape-memory blade arm 4 and the spinner blade 5 are able emit reflective flash and pulsing vibration to attract fish. Since the shape-memory blade arm 4 extends from a top edge of the weighted jig mold 2, the configuration between the shape-memory blade arm 4 and the spinner blade 5 are able to protect the barbed end 16 of the hook 1 from getting caught in cover, weeds, and any other types of obstructions. For example, when the present invention is positioned adjacent to any types of obstructions or pulled through any obstructions, the spinner blade 5 bends toward the barbed end 16 and covers the barbed end 16 as the present invention navigates through the obstructions. Once the present invention clears the obstructions, the shape-memory blade arm 4 regains its original form and allows the spinner blade 5 to revert back to the initial stage. Additionally, the configuration between the shape-memory blade arm 4 and the spinner blade 5 allow the present invention to collapse as a fish strikes and then to push the hook 1 against the fish's mouth. As a result, the present invention is able to allow for a solid bite and fewer missed fish.

Although the invention has been explained in relation to its preferred embodiment, it is to be understood that many other possible modifications and variations can be made without departing from the spirit and scope of the invention as hereinafter claimed.

What is claimed is:

1. A bladed jig head comprises:
a hook;
a weighted jig mold;
a plurality of lure skirts;
a shape-memory blade arm;
a spinner blade;
a shank of the hook and the shape-memory blade arm being perpendicularly connected to each other by the weighted jig mold;
the hook being concealed by the plurality of lure skirts;
the plurality of lure skirts being perimetrically attached around the weighted jig mold;
the spinner blade being rotatably attached to the shape-memory blade arm by a swivel; and
the spinner blade and the weighted jig mold being oppositely positioned of each other along the shape-memory blade arm.

2. The bladed jig head as claimed in claim 1 comprises:
the hook comprises an eye, a bend, and a barbed end;
the barbed end being adjacently positioned with the bend;
the shank being adjacently positioned with the bend, opposite of the barbed end; and
the eye being adjacently positioned with the shank, opposite of the bend.

3. The bladed jig head as claimed in claim 1, wherein the weighted jig mold is molded into a hull shaped head.

4. The bladed jig head as claimed in claim 1 comprises:
the shape-memory blade arm comprises a superelastic wire, a L-shaped sleeve, and a double barrel clamp sleeve;
the superelastic wire comprises a L-shaped bend section, an elongated section, and an U-shaped bend section;
the L-shaped bend section being adjacently positioned with the elongated section;
the U-shaped bend section being adjacently positioned with the elongated section, opposite of the L-shaped bend section;
the L-shaped bend section being encircled by the L-shaped sleeve; and
the U-shaped bend section being crimped onto the elongated section by the double barrel clamp sleeve.

5. The bladed jig head as claimed in claim 4, wherein the superelastic wire is Nitinol.

6. The bladed jig head as claimed in claim 1 comprises:
the shape-memory blade arm comprises a superelastic wire and a L-shaped sleeve;
the L-shaped sleeve and a L-shaped bend section of the superelastic wire being adjacently positioned with an eye of the hook;
an elongated section of the superelastic wire being oriented perpendicular to the shank; and
a first end of the shank and the L-shaped sleeve being encircled by the weighted jig mold.

7. The bladed jig head as claimed in claim 1 comprises:
a front portion of the weighted jig mold being adjacently positioned with an eye of the hook;
a rear portion of the weighted jig mold being adjacently positioned with a second end of the shank;
the rear portion, the second end, a bend of the hook, and a barbed end of the hook being concealed by the plurality of lure skirts; and
the plurality of lure skirts being perimetrically attached around the rear portion.

8. The bladed jig head as claimed in claim 1 comprises:
the shape-memory blade arm comprises a superelastic wire and a double barrel clamp sleeve; and
the spinner blade being rotatably secured within an U-shaped bend section of the superelastic wire and the double barrel clamp sleeve by the swivel.

9. A bladed jig head comprises:
a hook;
a weighted jig mold;
a plurality of lure skirts;
a shape-memory blade arm;
a spinner blade;
the shape-memory blade arm comprises a superelastic wire, a L-shaped sleeve, and a double barrel clamp sleeve;
the superelastic wire comprises a L-shaped bend section, an elongated section, and an U-shaped bend section;
the L-shaped bend section being adjacently positioned with the elongated section;
the U-shaped bend section being adjacently positioned with the elongated section, opposite of the L-shaped bend section;
the L-shaped bend section being encircled by the L-shaped sleeve;
the U-shaped bend section being crimped onto the elongated section by the double barrel clamp sleeve;
a shank of the hook and the shape-memory blade arm being perpendicularly connected to each other by the weighted jig mold;
the hook being concealed by the plurality of lure skirts;
the plurality of lure skirts being perimetrically attached around the weighted jig mold;
the spinner blade being rotatably attached to the shape-memory blade arm by a swivel; and
the spinner blade and the weighted jig mold being oppositely positioned of each other along the shape-memory blade arm.

10. The bladed jig head as claimed in claim 9 comprises:
the hook comprises an eye, a bend, and a barbed end;
the barbed end being adjacently positioned with the bend;
the shank being adjacently positioned with the bend, opposite of the barbed end; and
the eye being adjacently positioned with the shank, opposite of the bend.

11. The bladed jig head as claimed in claim 9, wherein the weighted jig mold is molded into a hull shaped head.

12. The bladed jig head as claimed in claim 9, wherein the superelastic wire is Nitinol.

13. The bladed jig head as claimed in claim 9 comprises:
the L-shaped sleeve and the L-shaped bend section being adjacently positioned with an eye of the hook;
the elongated section being oriented perpendicular to the shank; and
a first end of the shank and the L-shaped sleeve being encircled by the weighted jig mold.

14. The bladed jig head as claimed in claim 9 comprises:
a front portion of the weighted jig mold being adjacently positioned with an eye of the hook;
a rear portion of the weighted jig mold being adjacently positioned with a second end of the shank;
the rear portion, the second end, a bend of the hook, and a barbed end of the hook being concealed by the plurality of lure skirts; and
the plurality of lure skirts being perimetrically attached around the rear portion.

15. The bladed jig head as claimed in claim 9, wherein the spinner blade being rotatably secured within the U-shaped bend section and the double barrel clamp sleeve by the swivel.

16. A bladed jig head comprises:
a hook;
a weighted jig mold;
a plurality of lure skirts;
a shape-memory blade arm;
a spinner blade;
the shape-memory blade arm comprises a superelastic wire, a L-shaped sleeve, and a double barrel clamp sleeve;
the superelastic wire comprises a L-shaped bend section, an elongated section, and an U-shaped bend section;
the L-shaped bend section being adjacently positioned with the elongated section;
the U-shaped bend section being adjacently positioned with the elongated section, opposite of the L-shaped bend section;
the L-shaped bend section being encircled by the L-shaped sleeve;
the U-shaped bend section being crimped onto the elongated section by the double barrel clamp sleeve;
a shank of the hook and the shape-memory blade arm being perpendicularly connected to each other by the weighted jig mold;
the hook being concealed by the plurality of lure skirts;
the plurality of lure skirts being perimetrically attached around the weighted jig mold;
the spinner blade being rotatably secured within the U-shaped bend section and the double barrel clamp sleeve by the swivel; and
the spinner blade and the weighted jig mold being oppositely positioned of each other along the shape-memory blade arm.

17. The bladed jig head as claimed in claim 16 comprises:
the hook comprises an eye, a bend, and a barbed end;
the barbed end being adjacently positioned with the bend;
the shank being adjacently positioned with the bend, opposite of the barbed end; and
the eye being adjacently positioned with the shank, opposite of the bend.

18. The bladed jig head as claimed in claim 16 comprises:
wherein the weighted jig mold is molded into a hull shaped head; and
wherein the superelastic wire is Nitinol.

19. The bladed jig head as claimed in claim 16 comprises:
the L-shaped sleeve and the L-shaped bend section being adjacently positioned with an eye of the hook;
the elongated section being oriented perpendicular to the shank; and
a first end of the shank and the L-shaped sleeve being encircled by the weighted jig mold.

20. The bladed jig head as claimed in claim 16 comprises:
a front portion of the weighted jig mold being adjacently positioned with an eye of the hook;
a rear portion of the weighted jig mold being adjacently positioned with a second end of the shank;
the rear portion, the second end, a bend of the hook, and a barbed end of the hook being concealed by the plurality of lure skirts; and
the plurality of lure skirts being perimetrically attached around the rear portion.
